(19) United States
(12) Patent Application Publication
(10) Pub. No.: US 2007/0261673 A1
(43) Pub. Date: Nov. 15, 2007

(54) Fuel Injector with Punch-Formed Valve Seat for Reducing Armature Stroke Drift

(76) Inventors: Markus Rueckle, Stuttgart (DE); Axel Schnaufer, Calw (DE); Joachim Leicht, Korb-Kleinheppach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/576,618

(22) PCT Filed: Oct. 5, 2005
(86) PCT No.: PCT/EP05/55006

§ 371 Date: Apr. 4, 2007

(30) Foreign Application Priority Data
Oct. 9, 2004 (DE) 10 2004 049 288.3

(51) Int. Cl. F02M 61/16

(52) U.S. Cl. 123/445

(57) ABSTRACT

The invention relates to a method for manufacturing a fuel injector for an internal combustion engine that has a control valve, which opens or closes an outlet throttle from a control chamber and in which a closing element is moved into a valve seat in order to close the outlet throttle. The valve seat is produced by punch-forming using a forming punch. The invention also relates to a fuel injector that is manufactured in accordance with this method.

### TECHNICAL FIELD

In fuel injected internal combustion engines, the fuel is supplied to the individual combustion chambers via fuel injectors with hydraulically actuated nozzle needles. To this end, the fuel injector is provided with a valve, which is triggered, for example, electromagnetically or by means of a piezoelectric actuator. The valve opens or closes an outlet throttle of the control chamber that is connected to the nozzle needle.

### PRIOR ART

In fuel injectors of the kind known from the prior art, the housing of the fuel injector contains a valve component, which in turn contains an outlet throttle connected to a control chamber. A closing element opens or closes the outlet throttle. To this end, the valve component contains a conical valve seat into which the outlet throttle feeds. A spherical closing element is positioned in the conical valve seat in order to close the outlet throttle.

To achieve the high opening and closing speeds of the fuel injector required for operation of an internal combustion engine, the closing element of the control valve is moved into its seat or lifted up from it at a high speed. This continuous switching of the closing element generates wear on the valve seat. This wear results in armature stroke drift. In other words, the distance that the closing element must travel in order to close the outlet throttle increases due to the wear. The increased stroke distance of the closing element also increases the stroke distance of the magnet armature in a magnet-controlled valve and increases the actuator stroke in a piezoelectric actuator. This results in longer opening and closing times of the control valve and therefore longer opening times of the injection opening, resulting in higher injection quantities. These increased injection quantities of fuel delivered into the combustion chambers of the internal combustion engine lead to greater engine emissions and more combustion noise.

### DEPICTION OF THE INVENTION

To reduce wear on the valve seat and thus to reduce armature stroke drift, in the method according to the invention for manufacturing a fuel injector for an internal combustion engine that has a control valve, which opens or closes an outlet throttle from a control chamber and in which a closing element is moved into a valve seat in order to close the outlet throttle, the valve seat is produced by means of punch-forming using a forming punch. This prevents plastic wear on the valve seat during operation of the fuel injector.

In a preferred embodiment form, the forming punch used for punch-forming the valve seat is embodied in the shape of the closing element.

With the use of a spherical closing element that is moved into a conical valve seat, the forming punch is preferably embodied in the shape of a sphere with a truncated cone extending out tangentially from it. In a particularly preferred embodiment form, the truncated cone has an opening angle that is greater than or equal to the opening angle of the conically embodied valve seat. This prevents material, which has been displaced by the punch-forming action, from forming a raised area on the side of the punching location oriented toward the outlet throttle. When the valve is open, this raised area produces a more powerful throttling of the fuel flow. As a result, the volumetric flow of fuel out of the control chamber is reduced, which likewise reduces the opening speed of the injection openings.

In order to deform the valve seat and not the forming punch during the punch-forming of the valve seat, the forming punch is preferably provided with a surface that is comprised of a hard metal. In a preferred embodiment form, the entire forming punch is comprised of a hard metal. Hard metals known to those skilled in the art include, for example, sintered materials comprised of tungsten carbide, titanium carbide, tantalum carbide, molybdenum carbide, and cobalt. The hard metal preferably has a hardness in the range from 1300 to 1800 HV30.

In the internal combustion engine fuel injector embodied according to the invention that has a control valve, which opens or closes an outlet throttle from a control chamber and in which a closing element is moved into a valve seat to close the outlet throttle, the valve seat is formed by punch-forming.

In a preferred embodiment form, the valve seat of the control valve is embodied in a conical form. The preferred closing element for closing or opening the conically embodied valve seat is embodied in a spherical form.

In another embodiment form, the valve seat is embodied in a valve component contained in the housing of the fuel injector.

### DRAWINGS

The invention will be explained in greater detail below in conjunction with the drawings.

FIG. 1 shows a fuel injector for a high-pressure accumulator injection system,

FIG. 1.1 shows the detail A from FIG. 1,

FIG. 2 shows a conically embodied valve seat on which a forming punch is currently acting,

FIG. 3 shows a contour plot of a conically embodied valve seat according to the prior art,

FIG. 4 shows a contour plot of a first embodiment form of a conically embodied, punch-formed valve seat, and

FIG. 5 shows a contour plot of a second embodiment form of a conically embodied, punch-formed valve seat.

### EMBODIMENT VARIANTS

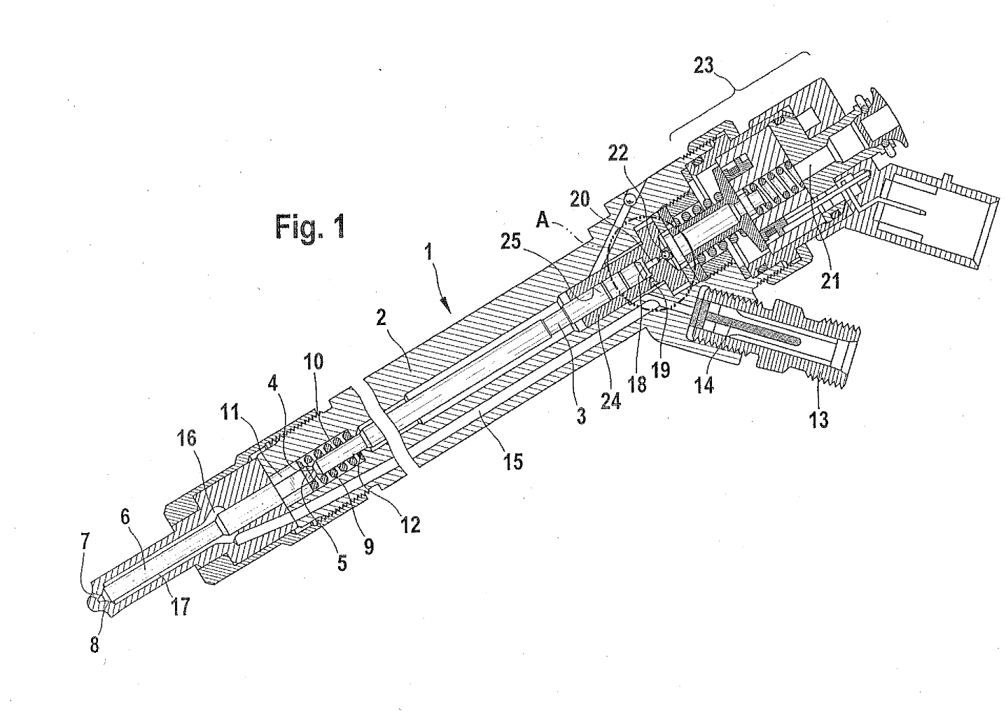

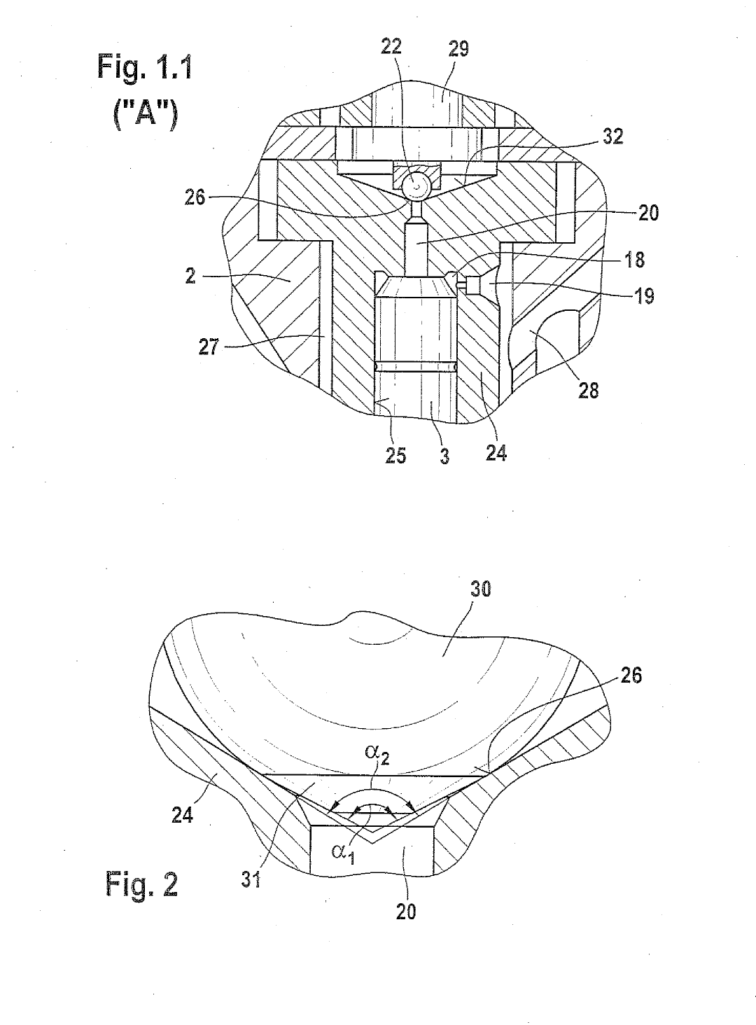

FIG. 1 shows a fuel injector for a high-pressure accumulator injection system.

A fuel injector 1 includes an injector body 2 in which a valve piston 3 is guided. With an end surface 4, the valve piston 4 acts on a pressure pin 5, which is embodied on a nozzle needle 6. At the end oriented toward a combustion chamber, not shown here, at least one injection opening 7 is provided in the injector body 2. When the injection opening 7 is closed, the end surface 4 of the valve piston 3 exerts a compressive force on the pressure pin 5 of the nozzle needle 6. In so doing, the nozzle needle 6 is moved into a seat 8 and thus, the at least one injection opening 7 is closed. In addition to the compressive force of the valve piston 3 on the pressure pin 5, a spring element 9 embodied in the form of a compression spring acts on the nozzle needle 6. The spring element 9 embodied as a compression spring is preferably a helical spring. In the embodiment form shown in FIG. 1, this spring encompasses the pressure pin 5 of the nozzle needle 6 and the part of the valve piston 3 oriented toward the nozzle needle 6. To this end, the spring element 9 is contained in a valve chamber 10. One end of the spring element 9 acts on a stepped enlargement 11 of the nozzle needle 6 and its other end acts on the end surface 12 of the valve chamber 10.

A connection fitting 13 that is connected to a high-pressure accumulator, not shown here, supplies fuel to the fuel injector 1. The connection fitting 13 contains a fuel filter 14 that filters out particles contained in the fuel in order to prevent wear-induced damage in the fuel injector 1. The fuel filter 14 is adjoined by a conduit 15 that conveys the fuel to a nozzle chamber 16. From the nozzle chamber 16, the fuel flows through an annular gap 17 to the injection opening 7.

At the end oriented away from the nozzle needle 6, the valve piston 3 ends in a control chamber 18. The control chamber 18 is supplied with fuel via an inlet throttle 19. The inlet throttle 19 likewise adjoins the fuel filter 14 so that system pressure also prevails on the influx side of the inlet throttle 19. The fuel from the control chamber 18 travels via an outlet throttle 20 into a low-pressure-side outlet fitting 21 that is connected, for example, to a fuel tank not shown here.

The outlet throttle 20 can be opened and closed by a closing element 22, which is embodied in a spherical form here.

When the outlet throttle 20 is closed, system pressure prevails in the control chamber 18, the valve chamber 10, and the nozzle chamber 16. Because the end surface that delimits the control chamber 18 has an area greater than the areas of the valve piston 3 oriented in the opposite direction, the compressive force acting in the direction of the at least one injection nozzle 7 is greater than the compressive force acting in the opposite direction, causing the nozzle needle 6 to move into its seat 8, thus closing the at least one injection opening 7. As soon as the closing element 22 has lifted away from its seat and thus opened the outlet throttle 20, the pressure in the control chamber 18 decreases. As a result of this, the compressive force acting in the direction of the at least one injection opening 7 also decreases. The valve piston 3 moves in the direction of the outlet throttle 20. At the same time, the nozzle needle 6 lifts away from its seat, thus uncovering the at least one injection opening 7.

In the embodiment variant shown here, an electrically controlled solenoid valve 23 triggers the closing element 22. In lieu of the solenoid valve 23, however, it is also possible to use a piezoelectric actuator to trigger the closing element 22, possibly with the interposition of a hydraulic coupler or a pressure booster.

To facilitate production and assembly of the fuel injector 1, the injector body 2 has a valve component 24 inserted into it, which contains the control chamber 18 together with the inlet throttle 19 and outlet throttle 20. The valve component 24 also contains a bore 25 in which the valve piston 3 is guided.

FIG. 1.1 shows the detail A from FIG. 1.

FIG. 1.1 shows the valve piston 3 in its upper position, i.e. when the injection opening 7 is opened. In order to close the injection opening 7, the outlet throttle 20 is closed. To accomplish this, the closing element 22 is moved into a valve seat 26. In order for the closing element 22 to close the outlet throttle 20 in a pressure-tight fashion, the valve seat 26 is situated in a conically embodied end surface 32 of the valve component 24. In the embodiment form shown here, the outlet throttle 20 opens out conically in the direction of the closing element 22. Closing the outlet throttle 20 interrupts the connection to the low-pressure part of the fuel system. The inlet throttle 19, which is connected to the high-pressure accumulator via an annular chamber 27 and an inlet conduit 28, supplies the control chamber 18 with fuel at system pressure. The pressure in the control chamber 18 likewise rises back to system pressure. Because of the increasing pressure in the control chamber 18, the compressive force acting on the valve piston 3 increases and the valve piston 3 moves toward the at least one injection opening 7. Since the end surface 4 of the valve piston 3 communicates with the pressure pin 5 of the nozzle needle 6, the nozzle needle 6 is likewise moved toward the at least one injection opening 7, thus closing it.

The closing element 22 is connected to an armature of the solenoid valve 23 via a piston 29. When a piezoelectric actuator is used in lieu of the solenoid valve 23, the piezoelectric actuator acts on the piston 29 directly.

In order to prevent the valve seat from wearing due to the high speeds with which the closing element 22 is moved into it, which results in a greater armature stroke and therefore a longer closing time, the valve seat 26 in the fuel injector according to the invention is punch-formed. The punch-forming reduces the Hertzian surface pressure by increasing the percentage of contact area. In other words, the punch-forming increases the contact area of the closing element 22 against the valve seat 26. The reduced surface pressure exerts less force on the valve seat 26, which reduces the wear on it. A further advantage to punch-forming the valve seat 26 is that the material is hardened in the punching region. The material hardening provides a further reduction in wear. It also smoothes roughness peaks created in the course of production.

The punch-forming of the valve seat 26 anticipates seat wear and minimizes the wear between the valve seat 26 and the closing element 22 during operation. This can largely prevent the rise in preinjection quantity due to the increase in armature stroke during operation of the fuel injector. Rising injection quantities during operation of the internal combustion engine lead to increased engine emissions, increased combustion noise, and more stress on the engine as a whole.

The punch-forming of the valve seat 26 is carried out, for example, by a forming punch that is made of a hard metal and is embodied in the shape of the closing element 22.

FIG. 2 shows a valve seat into which a forming punch has been placed.

In order, during the punch-forming process, to prevent the formation of a raised area on the side of the valve seat 26 oriented toward the outlet throttle 20, in a valve with a spherical closing element 22 and a conical valve seat 26, the forming punch 30 is embodied in the form of a sphere with a truncated cone 31 extending out tangentially from it. The truncated cone 11 prevents a raised area from forming along the spherical shape due to the fact that the truncated cone 31 punches the material in the direction of the likewise conically embodied valve seat 26.

If a raised area of this kind forms during the punch-forming of the valve seat 26, this reduces the flow cross-section when the valve is open. As a result, the valve functions as a throttle, thus reducing the volumetric flow of fuel flowing out through the outlet throttle 20. The volumetric flow of fuel reduced in this fashion results in a slower pressure drop in the control chamber 18 and therefore also to a reduced opening speed of the nozzle needle 6. This also alters the injection behavior, which can have a negative influence on the combustion process in the combustion chamber of the engine.

The truncated cone 31 preferably has an opening angle α₁ that is greater than the opening angle α₂ of the valve seat 26. With the same opening angle α₁ of the truncated cone 31 and opening angle α₂ of the valve seat 26, it is possible that during the punch-forming process, part of the material will be pressed in the direction of the outlet throttle 20. In this case, a ridge forms at the transition from the valve seat 26 into the outlet throttle 20 at which the opening angle changes. This ridge has a negative influence on fuel flow.

In a preferred embodiment form, the opening angle α₁ is 0 to 10 degrees greater than the opening angle α₂ of the valve seat 26. A greater opening angle α₁ of the truncated cone 31 means that a raised area forms at the punching location in the region of the valve seat 26 on the side of the truncated cone 31 and this raised area exerts an additional throttling action on the fuel flow.

Even with a non-spherical closing element 22, it is possible to reduce wear on the valve seat 26 by punch-forming the valve seat 26. In the event of a conical valve seat 26 in order to prevent a raised area from forming in the region of the valve seat 26, even with a non-spherical closing element 22, the forming punch 30, which is embodied in the shape of the closing element 22, is preferably provided with a truncated cone 31 whose opening angle α₁ is greater than the opening angle α₂ of the valve seat 26. Thus with a conical valve seat 26, the closing element 22, in addition to being embodied in the spherical shape, can also be embodied, for example, in the form of a paraboloid or a cylinder.

In addition to the truncated cone 31, it is also possible for the forming punch 30 to terminate in the form of a cone whose vertex angle is greater than or equal to the opening angle α₂ of the valve seat 26.

Any material that is harder than the material from which the valve seat 26 is produced is suitable for use as the material for the forming punch. Particularly suitable materials for the forming punch 30 include, for example, hard metals selected from the group of hard metals K 01-K 40. Depending on their composition, these hard metals have a hardness of 1300 to 1800 HV 30. The hard metals here include sintered materials comprised of tungsten carbide, titanium carbide, tantalum carbide, molybdenum carbide, and cobalt. In addition to hard metals, other materials suitable for this purpose include, for example, compression-proof ceramics that are harder than the material of which the valve seat 26 is produced.

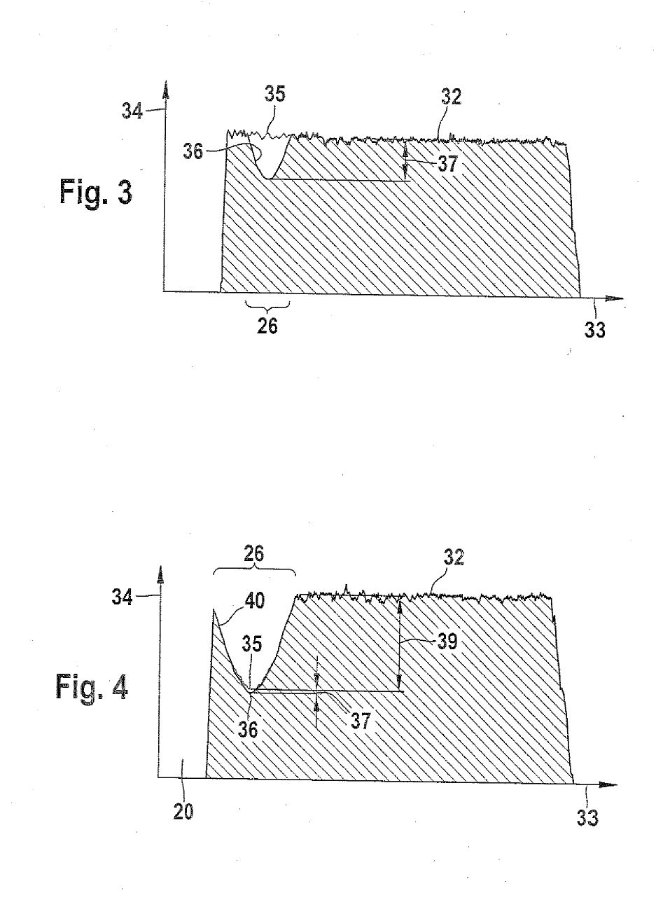

FIG. 3 shows a contour plot of a conically embodied valve seat according to prior art.

The length in mm of the conically embodied end surface 32 of the valve component 24 containing the valve seat 26 is plotted on the abscissa 33 of the graph in FIG. 3. The ordinate 34 expresses the surface roughness in μm. The line labeled with the reference numeral 35 represents the surface of the conically embodied end surface of the valve element 24 before the closing element 22 is moved into the valve seat 26 for the first time. It is readily apparent here that the surface of the end 32 of the valve component 24 has a production-induced roughness. The switching of the closing element 22 repeated millions of times generates wear in the valve seat 26. The closing element 22 produces an indentation 36 in the region of the valve seat 26. The indentation 36 has a wear depth 37 that is significantly greater than the average surface roughness of the end surface 32 of the valve component 24. Because the opening and closing distances of the closing element 22 are only very slight, the wear depth 37 causes a significant increase in closing distance for the closing of the control valve. This likewise results in a slower closing of the injection opening 7 and therefore a larger fuel quantity being injected into the combustion chamber. This leads to higher engine emissions and more combustion noise.

FIG. 4 shows a contour plot of a conically embodied, punch-formed valve seat in which the valve seat is punch-formed using a spherical forming punch.

It is clear from FIG. 4 that before the first closing of the control valve, the surface 35 is a significantly smoother if the valve seat 26 is punched. The punching depth to which the valve seat 26 is punched is labeled with the reference numeral 39. Because of the spherical forming punch, the punch-formed valve seat 26 has the cross section of a circular segment. This causes a raised area 40 to form on the side oriented toward the outlet throttle 20. When the outlet throttle 20 is open, the raised area 40 reduces the flow cross-section. For this reason, the valve seat 26 functions as an additional throttle when the outlet throttle 20 is open.

The punching of the valve seat 26 hardens the material in the vicinity of the valve seat 26. Thanks to this material hardening, in combination with the larger contact surface of the closing element 22 in the valve seat 26, even after a large number of opening and closing movements of the closing element 22, the indentation 36 that forms has only a slight wear depth 37 in comparison to the valve seat 26 that is not punched.

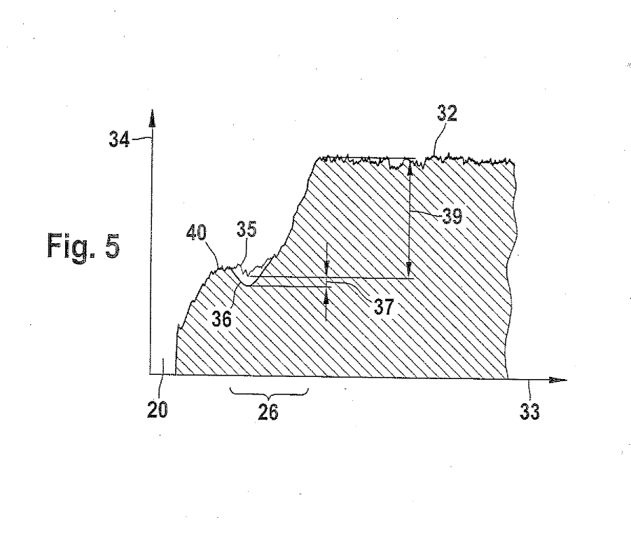

FIG. 5 shows the end surface 32 of the valve component 24 with the valve seat 26 punch-formed into it using a spherical forming punch in which a truncated cone extends tangentially out from the sphere. When a forming punch of this kind is used, this also yields a roughness of the surface 35 before the first closing of the control valve that is less than in a valve seat 26 that is not punched. The conical extension on the forming punch 30 results in the production of only a slight raised area 40 on the side of the valve seat 26 oriented toward the outlet throttle 20. In addition, when a forming punch 30 is used, which is embodied in the shape of a sphere with a truncated cone 31 extending tangentially from it, after a large number of opening and closing movements of the closing element 22, an indentation 36 forms that has only a slight wear depth 37 in comparison to the valve seat 26 that is not punch-formed. The punching depth of the punch-formed valve seat 26 is also labeled with the reference numeral 39 in FIG. 5.

### REFERENCE NUMERAL LIST

1 fuel injector
2 injector body
3 valve piston
4 end surface
5 pressure pin
6 nozzle needle
7 injection opening
8 seat
9 spring element
10 valve chamber
11 stepped enlargement
12 end surface of valve chamber 10
13 connection fitting
14 fuel filter
15 conduit
16 nozzle chamber
17 annular gap
18 control chamber
19 inlet throttle
20 outlet throttle
21 outlet fitting
22 closing element
23 solenoid valve
24 valve component
25 bore
26 valve seat
27 annular chamber
28 inlet conduit
29 piston
30 forming punch
31 truncated cone
32 end surface
33 abscissa
34 ordinate
35 surface before first closing
36 indentation
37 wear depth
38 seat width
39 punching depth
40 raised area
α₁ opening angle of truncated cone 31
α₂ opening angle of valve seat 26

1-9. (canceled)

10. In a method for manufacturing a fuel injector for an internal combustion engine that has a control valve, which opens or closes an outlet throttle from a control chamber and in which a closing element is moved into a valve seat in order to close the outlet throttle, the improvement comprising producing the valve seat by punch-forming using a forming punch.

11. The method according to claim 10, wherein the forming punch is embodied in the shape of the closing element.

12. The method according to claim 10, wherein the forming punch is embodied in the shape of a sphere with a truncated cone extending tangentially from it.

13. The method according to claim 12, wherein the truncated cone has an opening angle that is greater than or equal to the opening angle of the conically embodied valve seat.

14. The method according to claim 10, wherein the surface of the forming punch is comprised of a hard metal.

15. The method according to claim 11, wherein the surface of the forming punch is comprised of a hard metal.

16. The method according to claim 12, wherein the surface of the forming punch is comprised of a hard metal.

17. The method according to claim 13, wherein the surface of the forming punch is comprised of a hard metal.

18. In a fuel injector for an internal combustion engine, having a control valve that opens or closes an outlet throttle from a control chamber and in which a closing element is moved into a valve seat in order to close the outlet throttle, the improvement wherein the valve seat is produced by means of punch-forming.

19. The fuel injector according to claim 18, wherein the valve seat is embodied in a conical form.

20. The fuel injector according to claim 18, wherein the closing element is embodied in a spherical form.

21. The fuel injector according to claim 18, wherein the valve seat is embodied in a valve component.

22. The fuel injector according to claim 19, wherein the valve seat is embodied in a valve component.

23. The fuel injector according to claim 20, wherein the valve seat is embodied in a valve component.
